(19) United States
(12) Patent Application Publication
(10) Pub. No.: US 2020/0159511 A1
(43) Pub. Date: May 21, 2020

(54) Methods Circuits Devices Systems and Associated Computer Executable Code for Providing Application Data Services to a Mobile Communication Device

(71) Applicant: SAGUNA NETWORKS LTD., Yokneam Illit (IL)

(72) Inventors: Daniel Nathan Frydman, Haifa (IL); Lior Fite, Zurit (IL)

(21) Appl. No.: 16/531,082

(22) Filed: Aug. 4, 2019

Related U.S. Application Data
(63) Continuation of application No. 14/982,511, filed on Dec. 29, 2015, now abandoned.
Application No. 14/982,511 is a continuation-in-part of application No. 14/459,343, filed on Aug. 14, 2014, now Pat. No. 10,348,573.
Application No. 14/982,511 is a continuation-in-part of application No. 14/045,047, filed on Oct. 3, 2013, now Pat. No. 9,578,586.
Application No. 14/982,511 is a continuation-in-part of application No. 13/861,192, filed on Apr. 11, 2013, now Pat. No. 9,642,169.
Application No. 14/982,511 is a continuation-in-part of application No. 13/739,067, filed on Jan. 11, 2013, now abandoned.
(60) Provisional application No. 62/097,160, filed on Dec. 29, 2014.
(60) Provisional application No. 61/940,510, filed on Feb. 17, 2014.
(60) Provisional application No. 61/723,356, filed on Nov. 7, 2012.
(60) Provisional application No. 61/723,356, filed on Nov. 7, 2012.
(60) Provisional application No. 61/622,574, filed on Apr. 11, 2012.
(60) Provisional application No. 61/585,251, filed on Jan. 11, 2012.

(51) Int. Cl. G06F 8/60; H04L 29/08; G06F 9/50; H04W 4/021; H04L 12/24

(52) U.S. Cl. CPC G06F 8/60; H04L 67/10; G06F 9/5077; H04W 40/02; H04W 4/021; H04L 41/5054; H04L 41/0806; G06F 9/5072

(57) ABSTRACT

Disclosed are methods, circuits, devices, systems and associated computer executable code for providing application data services to a mobile communication device. A communication module, including communication circuits, receives application data services demand information relating to demand for a given application data service being experienced by one or more access nodes of the mobile communication network. A controller on the network adjusts at least one parameter of an application data service being provided by at least one network edge appliance of the mobile communication network accordingly.

### RELATED APPLICATIONS:

The present application is a continuation application of U.S. application Ser. No.: 14/982,511 filed on Dec. 29, 2015, entitled “Methods Circuits Devices Systems and Associated Computer Executable Code for Providing Application Data Services to a Mobile Communication Device” which Application is hereby incorporated by reference in its entirety. U.S. application Ser. No.: 14/982,511 claims priority from U.S. Provisional Patent Application No.: 62/097,160 filed on Dec. 29, 2014, entitled “Methods Circuits Devices Systems and Associated Computer Executable Code for Providing Application Services to a Mobile Communication Device” which Provisional Patent Application is hereby incorporated by reference in its entirety.

The present application is a Continuation in Part Application of U.S. patant application Ser. NO. 13/739,067, filed Jan. 11, 2013 and entitled “METHODS, CIRCUITS, DEVICES, SYSTEMS AND ASSOCIATED COMPUTER EXECUTABLE CODE FOR PROVIDING DOMAIN NAME RESOLUTION”, which claims the benefit of US Provisional Patent Application 61/585,251, filed Jan. 11, 2012. U.S. patent application Ser. No. 13/739,067 and the provisional application from which it claims priority are hereby incorporated by reference in their entirety.

The present application is a Continuation in Part Application of U.S. patent application Ser. No. 14/045,047, filed Oct. 3, 2013 and entitled “METHODS CIRCUITS DEVICES SYSTEMS AND ASSOCIATED COMPUTER EXECUTABLE CODE FOR PROVIDING DATA CONNECTIVITY BETWEEN A MOBILE COMMUNICATION DEVICE COMMUNICATIVELY COUPLED TO A MOBILE COMMUNICATION NETWORK AND A THIRD PARTY DATA SOURCE”, which claims the benefit of U.S. Provisional Patent Application 61/723,356, filed Nov. 7, 2012. U.S. patent application Ser. No. 14/045,047 and the provisional application from which it claims priority are hereby incorporated by reference in their entirety.

The present application is a Continuation in Part of U.S. patent application Ser. No. 13/861,192, filed Apr. 11, 2013 and entitled “METHODS, CIRCUITS, DEVICES, SYSTEMS AND ASSOCIATED COMPUTER EXECUTABLE CODE FOR FACILITATING ACCESS TO A CONTENT SOURCE THROUGH A WIRELESS MOBILE NETWORK”, which claims the benefit of U.S. Provisional Patent Application 61/622,574, filed Apr. 11, 2012 and U.S. Provisional Patent Application 61/723,356, filed Nov. 7, 2012. U.S. patent application Ser No. 13/861,192 and the provisional applications from which it claims priority are hereby incorporated by reference in their entirety.

The present application is a Continuation in Part Application of U.S. patent application Ser. No. 14/459,343, filed Aug. 14, 2014 and entitled “Methods, Circuits, Devices, Systems and Associated Computer Executable Code for Facilitating Local Hosting and Access of Internet Based Information”, which claims the benefit of US Provisional Patent Application 61/940,510, filed Feb. 17, 2014. U.S. patent application Ser. No. 14/459,343 and the provisional application from which it claims priority are hereby incorporated by reference in their entirety.

### FIELD OF THE INVENTION

The present invention generally relates to the fields of communication and content delivery, and more particularly, to methods, circuits, devices, systems and associated computer executable code for providing application data services to a mobile communication device.

### BACKGROUND

Web caching/hosting is the temporary storage of web objects (such as HTML documents) for later retrieval. There are three significant advantages to web caching: reduced bandwidth consumption (fewer requests and responses that need to go over the network), reduced server load (fewer requests for a server to handle), and reduced latency (since responses for cached requests are available immediately, and closer to the client being served). Together, they make the web less expensive and better performing.

Caching can be performed by the client application, and is built in to most web browsers. There are a number of products that extend or replace the built-in caches with systems that contain larger storage, more features, or better performance. In any case, these systems cache net objects from many servers but all for a single user.

Caching can also be utilized in the middle, between the client and the server as part of a proxy. Proxy caches are often located near network gateways to reduce the bandwidth required over expensive dedicated internet connections. These systems serve many users (clients) with cached objects from many servers. In fact, much of the usefulness (reportedly up to 80% for some installations) is in caching objects requested by one client for later retrieval by another client. For even greater performance, many proxy caches are part of cache hierarchies, in which a cache can inquire of neighboring caches for a requested document to reduce the need to fetch the object directly.

Finally, caches can be placed directly in front of a particular server, to reduce the number of requests that the server must handle. Most proxy caches can be used in this fashion, but this form has a different name (reverse cache, inverse cache, or sometimes http accelerator) to reflect the fact that it caches objects for many clients but from (usually) only one server.

There still remains a need, in the fields of content delivery and local data hosting, caching and/or access, for solutions that may provide application services to mobile communication devices.

### SUMMARY OF THE INVENTION

The present invention may include methods, circuits, devices, systems and associated computer executable code for providing application services to a mobile communication device. According to some embodiments, one or more application data services provided by a mobile communication network, wherein the application data service may include specific cached content, may be automatically migrated or moved relatively closer to one or more access nodes of the network responsive to a detection of a change (e.g. increase) in demand for the services by one or more mobile communication devices communicatively coupled to the network through the one or more access nodes. According to some embodiments, one or more application data services hosted and/or provided by a mobile communication network edge appliance at or near one or more access nodes of the network may be modified, expanded or reduced responsive to detection of a change in demand, up or down, for that services by one or more mobile communication devices communicatively coupled to the network through the one or more access nodes.

According to some embodiments, there may be provided a mobile communication network including: (1) one or more access nodes; (2) at least one internet gateway; (3) at least one network management unit running on a computing platform; and (4) at least one network edge appliance residing at or near an access node of the mobile communication network and adapted to host, facilitate and/or otherwise provide application data services to a data client application running on a mobile communication device communicatively coupled to the network through the access node, such as a base-station. An access node, or group of access nodes, of a mobile communication network may also be considered and referred to as a network edge or a network access zone. The networked computing platform connected at or near the network edge may be considered and referred to as a network appliance and/or a network edge appliance. Application data services provided according to embodiments of the present invention may include: (a) DNS services, (b) Internet gateway services, (c) content caching services, and/or (d) application hosting services.

According to some embodiments, migrating or moving an application data service closer to an access node of a mobile communication network may include automatically installing, instancing, launching and/or activating computer executable code on a networked computing platform connected to the network at or near the access node, a network edge appliance, wherein the code provides the data service when executed. Migrating or moving an application data service closer to an access node may also include automatically uninstalling or otherwise terminating the service running on another computing platform elsewhere on the network.

Automatically modifying, expanding or reducing an application data service, hosted on or otherwise provide by a network edge appliance or device, responsive to detection of a change in demand, up or down, for that service by one or more mobile communication devices communicatively coupled to one or more access nodes supported by the network edge device, may involve reallocating computing resources, memory resources and/or communication resources of the network edge device for running computer executable code of the data service. According to further embodiments, modifying, expanding or reducing a data service may be performed predictively, for example based on previously detected hourly, daily, weekly and/or monthly service demand patterns of users on the mobile communication network.

According to some embodiments, there is provided a network edge appliance for a mobile communication network, including communication circuitry to receive data from one or more mobile communication devices communicatively coupled to a base-station of a network access zone and to transmit data to the one or more mobile communication devices communicatively coupled to the base-station. The appliance may include one or more physical computing host machines, each machine having access to computing resources. The Appliance may also include or be otherwise functionally associated with a Zone Data Service Management Unit (ZDSMU) to deploy, adjust or remove a given data service hosted on the one or more physical computing host machines responsive to a demand level for the given application data service by mobile communication devices communicatively coupled to the base-station of the network access zone.

According to embodiments, the ZSDMU may communicate with and receive instruction from a network Application Data Services Manager (ADSM), wherein the ADSM is may communicate with and manage multiple network edge appliances located across multiple network access zones. The ZSDMU may communicate data service demand levels for one or more data services from mobile devices within its zone to the ADSM. The ZSDMU may receive content and data service related computer executable code, for deployment on said network appliance, from an Edge Configuration and Content Hosting Deployment System (HDS) functionally associated with the ADSM.

The application data services which may be deployed, adjusted or removed from a network edge appliance of given network access zone may include: (a) application hosting, (b) content caching, (c) DNS service, and (d) Internet Gateway Access. Mobile communication devices communicatively coupled to access nodes (e.g. wireless access points or base-stations) of the network zone serviced by a network edge appliance may receive application data services provided by that network edge appliance instead of receiving the same services from another network appliance, either at the core of the mobile communication network or outside the mobile communication network. According to some embodiments, when new application data service is deployed to a network edge appliance associated with a given network access zone, a zone specific DNS for that zone may be updated in order to direct data client requests for the newly deployed application data service to the network edge appliance.

According to embodiments, demand levels for a given application data service may be detected in real-time by the ZDSMU or by a functionally associated network monitoring traffic device. Demand levels for one or more application data services may be predicted based on prior detections.

According to embodiments, deployment of application data services includes instancing or activating one or more virtual computing machines on one or more physical computing host machines, wherein said virtual computing machine may be allocated a portion of computing resources of the one or more physical computing host machine and a unique network identifier or address. Adjustment of the application data services includes adjusting a parameter of the virtual machine providing the given data service, wherein the parameter may be selected from the group consisting of: (a) allocated processor resources, (b) allocated storage, (c) allocated operating memory, (d) allocated network identifier, (e) allocated network bandwidth, and (f) data records stored by or otherwise accessible by the virtual machine.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

FIG. 1 shows a network diagram illustrating an exemplary mobile communication network topology according to embodiments of the present invention including a network edge appliance present at each of two access zones of the network and an Application Data Services Manager (ADSM) at the core of the network;

FIG. 2 shows a network diagram illustrating an exemplary mobile communication network topology according to embodiments of the present invention including a network edge appliances present at one access zone of the network and an application data services manager (ADSM) also residing at the same network access zone; and

FIG. 3 shows a functional block diagram of an exemplary Network Edge Appliance according to embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer or computing system, or similar electronic computing device, that manipulate and/or transform data represented as physical, such as electronic, quantities within the computing system' s registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk—read only memory (CD-ROM), compact disk—read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

The present invention includes methods, circuits, devices, systems and associated computer executable code for providing application data services to a mobile communication device. According to some embodiments, there may be provided a mobile communication network including at least one network edge appliance residing at or near an access node of the mobile communication network and adapted to facilitate and/or provide application data services to a data client application running on a mobile communication device communicatively coupled to the network through the access node. Provided data service may include DNS services, Internet gateway services, content cache and/or application hosting services.

The mobile communication network may include a plurality of network edge appliances, each appliance connected to a respective access node (e.g. base-station) or respective group of access nodes (e.g. network access zone with multiple base-stations), and each appliance facilitating and/or providing application data services to data client applications running on mobile communication devices connected to the network through a respective access node. Application data services provide by a first network edge appliance may defer at least partially from those provided by a second network edge appliance. According to some embodiments, application data services provided by at least some of the network edge appliances may be automatically deployed, initiated and/or terminated by an Application Data Services Manager (ADSM).

According to embodiments, a network edge appliance may host or otherwise provide a set of application data services to mobile clients communicatively coupled to the one or more access nodes functionally associated the network edge appliance. A proportion of a given appliance's total resources, computational, operating memory, storage, etc. allocated to one of the set of application data services being hosted may correspond to a demand level for that given application data service relative to demand for other application data services hosted on the same network edge appliance. According to embodiments, application data services whose demand falls below a threshold level may be completely terminated and/or uninstalled from edge appliances servicing the access nodes where the demand has fallen below the threshold level. Edge appliance resources may be allocated and reallocated to each of the set of application data services based on a load balancing scheme as described above.

For each access zone, comprised of one or more access nodes (e.g. access points or base-stations), a zone data services management unit (ZDSMU) may handle application data service deployment, modification and removal on one or more functionally associated network edge appliances. According to further embodiments, the ZDSMU may comprise: a communication module adapted to receive application data services demand information relating to demand being experienced by functionally associated access nodes of the mobile communication network and a controller adapted to adjust at least one parameter of an application data service being provided by at least one network edge appliance of the mobile communication network. The ZDSMU may be an application residing and running on physical hardware of one or more network edge appliances. The ZDSMU may deploy, modify and/or remove application data services in accordance with a local load balancing algorithm which takes into account demand levels for application data services by devices connected to only the access nodes being serviced within the ZDSMU' s zone. According to further embodiments, the ZDSMU may deploy, modify and/or remove application data services responsive to instructions from a (network level) Application Data Services Manager (ADSM) which may monitor and respond to application data service demand across multiple access zones. One or more active application data services and/or resources allocated thereto may be automatically adjusted by the ADSM, directly or through the ZDSMU, wherein adjustments of services at a given network edge appliance may be responsive to application data service demand at an access node or group of access nodes (access zone) being serviced by the given network edge appliance or at another access zone. Accordingly, a network edge appliance within a given access zone may allocate resources to each of a set of application data services based on both local (access-zone) and network-wide demand levels for some or all of the hosted application data services.

An ADSM according to embodiments may identify and monitor demand levels for application data services across multiple access zones of a mobile communication network according to embodiments. When a sufficiently high demand level for an application data service is identified coming from one or more access zones, the ADSM may automatically deploy or trigger deployment of the identified application data service, in the form of digital content and/or executable code, to network edge appliances functionally associated with one or more access zones. The threshold demand level for deployment of a new application data service to a given access zone edge appliance may be dynamic, and may at least be partially based on demand levels for other application data services in the access zones. The ADSM may trigger deployment, modification and removal of application data services on network edge appliances servicing monitored access zones based on a load balancing algorithm which takes into account demand across some or all of the monitored zones. Accordingly, embodiments of present invention may provide multi-factor and/or multi-tiered load balancing of application data services across network edge appliance of a mobile communication network.

According to further embodiments, the ADSM or a functionally associated module may receive data service demand information from each of at least some of the nodes and/or groups of nodes (access zones) and may apply a load balancing algorithm to determine or estimate a functionally appropriate distribution of application data services across the edge network appliances, wherein appropriate distribution may be intended to at least partially addressed data service demands being experienced by the network edge appliances, various other elements and communication pathways of the mobile communication network, and/or the mobile communication network as a whole.

According to yet further embodiments, the functionality of a ZDSMU and/or an ADSM may be performed by some or all of the network edge appliances operating in concert, possibly in accordance with a grid or collaborative computing methodology. According to some embodiments, the ZDSMU may operate without an ADSM. According to some embodiments, an ADSM may interact with a controller of one or more network edge appliances directly without the use of a ZDSMU.

According to further embodiments, an Application Data Services Manager (ADSM) for a mobile communication network, may comprise: a communication module adapted to receive application data services demand information relating to demand being experienced by two or more access nodes of the mobile communication network; and a controller adapted to adjust at least one parameter of an application data service being provided by at least one network edge appliance of the mobile communication network.

According to further embodiments, the adjusted parameter may for example be: a parameter indicative of which application data service related virtual server(s) is instanced or terminated (e.g. a Virtual Machine within a Virtual Machine environment or operating system hosted on the NEA); and/or a parameter (computational/memory) indicative of resource allocation to an application data service related virtual server.

According to further embodiments, a mobile communication network may comprise: two or more access nodes; an Application Data Services Manager (ADSM) adapted to receive application data services demand information relating to demand being experienced by two or more access nodes of the mobile communication network; and a controller adapted to adjust at least one parameter of an application data service being provided by at least one Network Edge Appliance (NEA) of the mobile communication network.

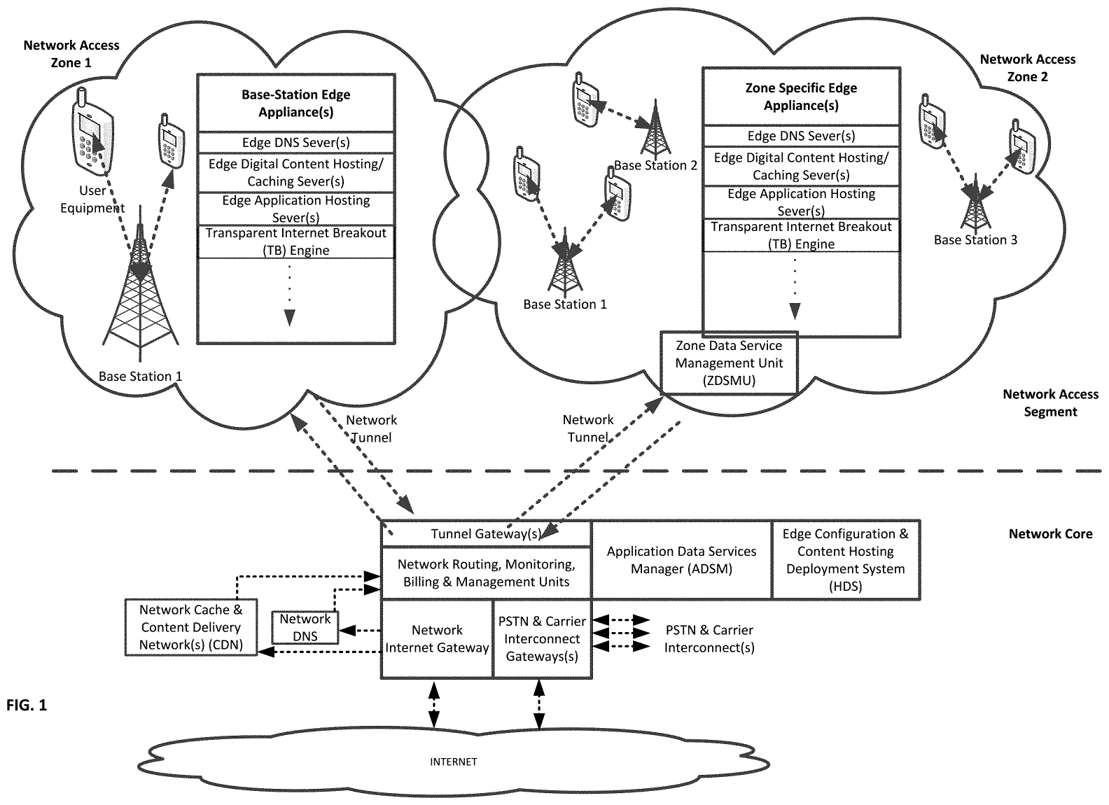

Turning now to FIG. 1, there is shown a network diagram illustrating an exemplary mobile communication network topology according to embodiments of the present invention including a network edge appliance present at each of two access zones of the network and an Application Data Services Manager (ADSM) at the core of the network. The network edge appliance of Network Access Zone 1 support one base-station and provides a DNS server, content caching, application hosting and transparent intent breakout to mobile communication devices connected to the one base-station. The edge appliance of zone 1 is configured directly by the ADSM at the core of the network, which ADSM is functionally coupled to an edge configuration and content hosting deployment system (HDS). Once the ADSM selects which application data services, including which digital content, to deploy and to want extent to the edge appliance in Zone 1, the HDS is signaled to execute transfer and possibly installation of the content and executable code required for deployment of the selected application data services on the edge appliance. The ADSM selects application data service for deployment, modification and/or removal based on demand levels from across the network.

Network access zone 2 includes an edge appliance servicing multiple base-stations of the zone. Zone 2 includes a functionally associated ZDSMU, which may be at least partially running on the edge appliance. The ZDSMU may perform application data service demand level monitoring of mobile communication devices connected to the network within zone 2. The ZDSMU may perform application data service management based on detected demand levels. The ZDSMU may also perform data service management based on instructions from the ADSM. The ZDSMU may receive digital content and code from the HDS.

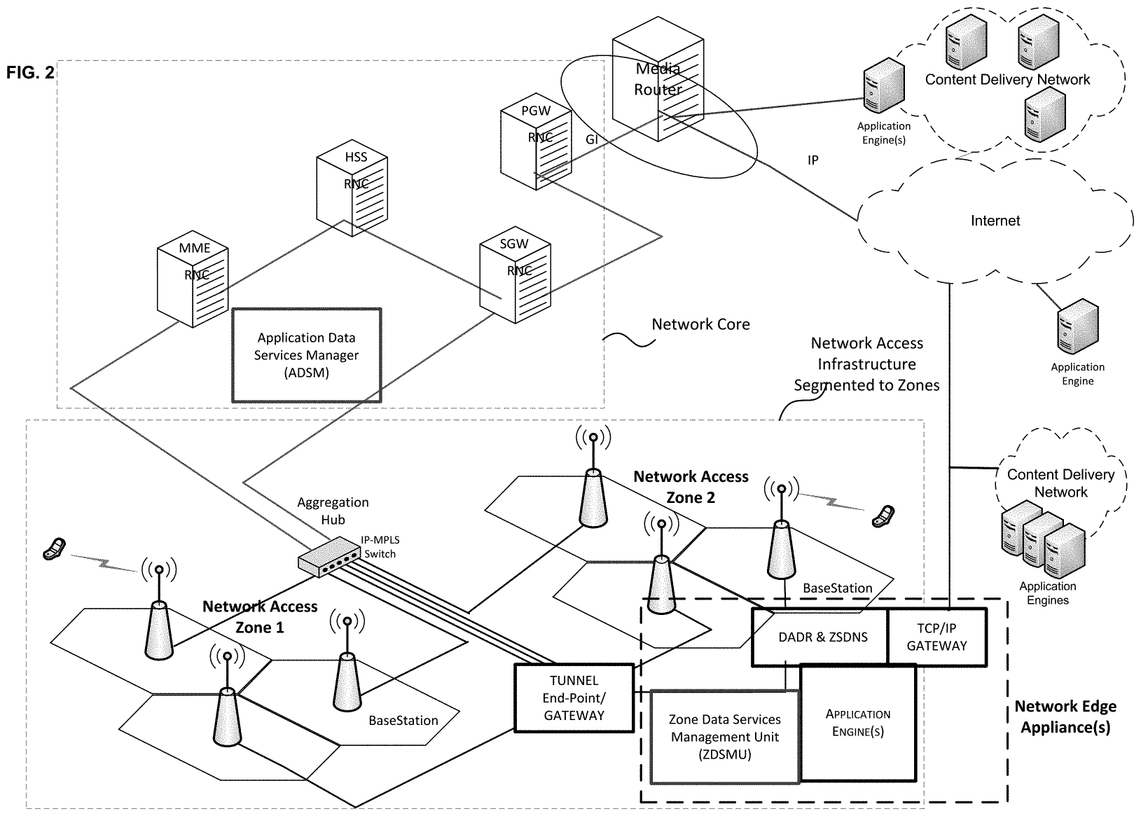

Turning now to FIG. 2, there is shown a network diagram illustrating an exemplary mobile communication network topology according to embodiments of the present invention including a network edge appliances present at one access zone of the network and an application data services manager (ADSM) also residing at the same network access zone. According to this embodiment, one zone two includes an edge appliance, which edge appliance is virtual machine. Shown running inside the edge appliance physical machine are the ZDSMU, a zone specific virtual DNS server, a virtual application server, a virtual dynamic data packet routing machine, and a virtual internet (breakout gateway) gateway to the public internet and/or content delivery networks outside the mobile communication network.

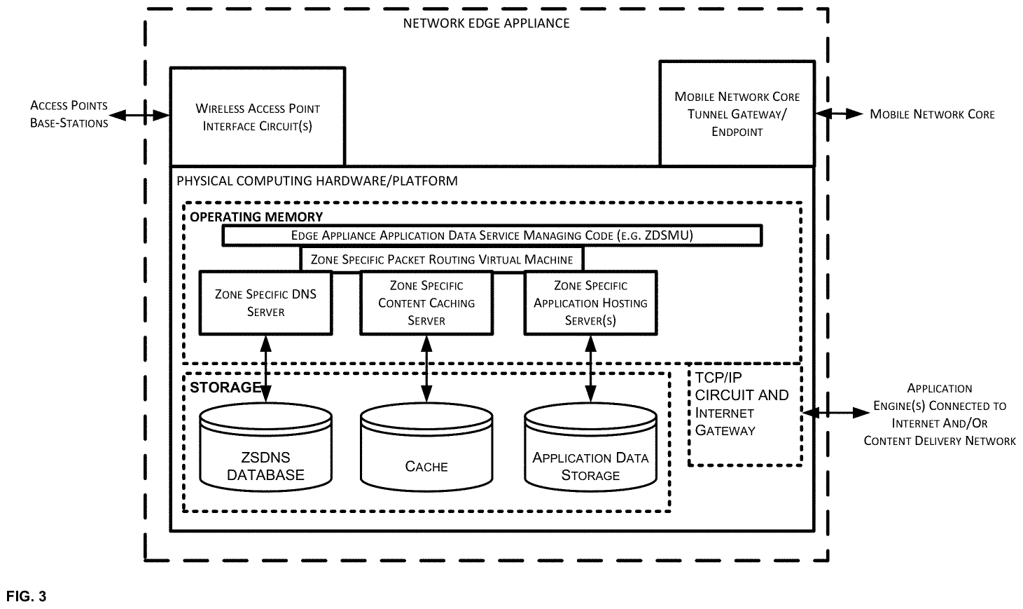

FIG. 3 shows a functional block diagram of an exemplary Network Edge Appliance according to embodiments of the present invention. The edge appliance includes communication circuitry to communicate with one or more access-points/base-stations of a mobile communication network and circuits to communicate with a network core. The edge appliance includes physical computing hardware including storage, operating memory and one or more processors running a virtual machine capable operating system (e.g. VMWARE) or environment. Integrated with the operating system or running within the virtual machine on is appliance data service managing code (e.g. ZDSMU). This code deploys and manages the virtual servers, providing application data services to mobile communication devices, as describer throughout this application. The code may do so based on monitoring application service demand, based on instructions from an external network controller and/or based on a combination of the two.

A virtual packet router may route application data service request packets from mobile communication device connected to a serviced access point to the relevant application data service providing server based on records in the zone specific DNS (ZSDNS) server database. The virtual packet routing machine may route packets generated by any of the data service providing servers responsive to a request packet back to the source of the request packet. The virtual packet routing machine may route service request packets to a TCP/IP gateway connected to the Internet if so designated by the ZSDNS. It may route response packets received at the TCP/IP gateway from an outside server to the source of the corresponding requesting. The virtual packet routing machine may route copies of some or all packets, from the mobile devices and from the internal and external servers, to the network core, optionally for billing and/or legal inspection.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A network edge appliance for a mobile communication network, said edge appliance comprising:
communication circuitry to receive data from one or more mobile communication devices communicatively coupled to a base-station of a network access zone and to transmit data to the one or more mobile communication devices communicatively coupled to the base-station;
one or more physical computing host machines, each machine having access to computing resources; and
processing circuitry running a Zone Data Service Management Unit (ZDSMU) to deploy, adjust or remove a given data service hosted on said one or more physical computing host machines responsive to a demand level for the given data service by mobile communication devices communicatively coupled to the base-station of the network access zone, wherein demand level for a given data service is calculated based on a one directional usage trend or a cyclical usage pattern for the given data service.

2. The network edge appliance according to claim 1, wherein the application data service deployed, adjusted or removed is selected from the group consisting of: (a) application hosting, (b) content caching, (c) DNS service, and (d) Internet Gateway Access.

3. The network edge appliance according to claim 1, wherein the demand level for the given service is detected in real-time by the ZDSMU or by a functionally associated network monitoring traffic device.

4. The network edge appliance according to claim 1, wherein the demand level for the given data service is predicted based on prior detections.

5. The network edge appliance according to claim 1, wherein deployment of the given application data service includes instancing or activating one or more virtual computing machines on said one or more physical computing host machines, wherein said virtual computing machine is allocated a portion of said computing resources of said one or more physical computing host machine and a unique network identifier or address.

6. The network edge appliance according to claim 5, wherein adjustment of the application data service includes adjusting a parameter of the virtual machine providing the given data service, wherein the parameter may be selected from the group consisting of: (a) allocated processor resources, (b) allocated storage, (c) allocated operating memory, (d) allocated network identifier, (e) allocated network bandwidth, and (f) data records stored by or otherwise accessible by the virtual machine.

7. The network edge appliance according to claim 1, wherein said ZSDMU is adapted to communicate with and receive instruction from a network Application Data Services Manager (ADSM), wherein said ADSM is adapted to communicate and manage multiple network edge appliances located across multiple network access zones.

8. The network edge appliance according to claim 7, wherein said ZSDMU is adapted to communicate data service demand levels for one or more data services to the ADSM.

9. The network edge appliance according to claim 7, wherein said ZSDMU is adapted to receive content and data service related computer executable code, for deployment on said network appliance, from an Edge Configuration and Content Hosting Deployment System (HDS) functionally associated with the ADSM.

10. The network edge appliance according to claim 9, wherein the ADSM or the HDS is a distributed grid computing entity comprised of portions of several edge appliances operating according to a cooperatively grid protocol.

11. A mobile communication network comprising one or more network access zones, wherein each network access zone includes at least one base-station to communicate with mobile communication devices within a coverage area; and
a network edge appliance located at or in communicative proximity to a base-station of the network and comprising: (1) communication circuitry to receive data from one or more mobile communication devices communicatively coupled to a base-station of a network access zone and to transmit data to the one or more mobile communication devices communicatively coupled to the base-station; (2) one or more physical computing host machines, each machine having access to computing resources; and (3) processing circuits running a Zone Data Service Management Unit (ZDSMU) to deploy, adjust or remove a given data service hosted on said one or more physical computing host machines responsive to a demand level for the given data service by mobile communication devices communicatively coupled to the base-station of the network access zone, wherein demand level for a given data service is calculated based on a one directional usage trend or a cyclical usage pattern for the given data service.

12. The network according to claim 11, wherein the application data service deployed, adjusted or removed is selected from the group consisting of: (a) application hosting, (b) content caching, (c) DNS service, and (d) Internet Gateway Access.

13. The network according to claim 11, wherein the demand level for the given service is detected in real-time by the ZDSMU or by a functionally associated network monitoring traffic device.

14. The network according to claim 11, wherein the demand level for the given data service is predicted based on prior detections.

15. The network according to claim 11, wherein deployment of the given application data service includes instancing or activating one or more virtual computing machines on said one or more physical computing host machines, wherein said virtual computing machine is allocated a portion of said computing resources of said one or more physical computing host machine and a unique network identifier or address.

16. The network according to claim 15, wherein adjustment of the application data service includes adjusting a parameter of the virtual machine providing the given data service, wherein the parameter may be selected from the group consisting of: (a) allocated processor resources, (b) allocated storage, (c) allocated operating memory, (d) allocated network identifier, (e) allocated network bandwidth, and (f) data records stored by or otherwise accessible by the virtual machine.

17. The network according to claim 11, wherein said ZSDMU is adapted to communicate with and receive instruction from a network Application Data Services Manager (ADSM), wherein said ADSM is adapted to communicate and manage multiple network edge appliances located across multiple network access zones.

18. The network according to claim 17, wherein said ZSDMU is adapted to communicate detected data service demand levels for one or more data services to the ADSM.

19. The network according to claim 17, wherein said ZSDMU is adapted to receive content and data service related computer executable code for deployment on said network appliance from an Edge Configuration and Content Hosting Deployment System (HDS) functionally associated with the ADSM.

20. The network edge appliance according to claim 19, wherein the ADSM or the HDS is a distributed grid computing entity comprised of portions of several edge appliances operating according to a cooperatively grid protocol.
